(19) United States
(12) Patent Application Publication
(10) Pub. No.: US 2004/0187568 A1
(43) Pub. Date: Sep. 30, 2004

(54) Device for measuring tyre pressure

(76) Inventor: Marcel Locatelli, Montbonnet (FR)

Correspondence Address: PEARNE & GORDON LLP, 1801 EAST 9TH STREET, SUITE 1200, CLEVELAND, OH, 44114-3108, US

(21) Appl. No.: 10/484,042

(22) PCT Filed: Jul. 24, 2002
(86) PCT No.: PCT/FR02/02648

(30) Foreign Application Priority Data
Jul. 26, 2001 (FR) 01/10002

(51) Int. Cl. B60C 23/02

(52) U.S. Cl. 73/146.3

(57) ABSTRACT

A tyre (6) pressure sensor comprises a pressure-sensitive part (8), in particular with a deformable membrane (10), mounted in the centre of the hub (7) of wheel (2), and a transducer part (12) housed in the axle (1) of wheel (2). This arrangement in which the sensor is separated into two mutually rotating parts is nonetheless more practical and simpler than devices in which electric connection is required between a wheel carrying the sensor assembly and the read device.

The invention applies in particular to aircraft.

The subject of this invention is a device for measuring the pressure of a tyre fitted to a wheel rim of a vehicle, which is mounted on the wheel to provide continuous measurement.

Such devices are found on aircraft tyres. One problem encountered is the transmitting of the measurement signal between the sensor, which moves together with the tyre and the wheel, and the signal reading means which are on a fixed part of the vehicle. Recourse is made either to a rotating connection, with brushes for example, at the junction of the wheel hub and its axle, or to wireless transmission by radio in particular; but these means are not always reliable and greatly increase the cost of the device.

The invention provides a different, improved device in particular in respect of the sensitive part of the sensor which changes appearance or position in relation to the pressure it receives, is not positioned against the tyre as is usual but on the contrary on the wheel hub in front of the axle, and is connected to the tyre by a pressure-taking tube connection. Also, the transducer part of the sensor which records changes in the sensitive part and converts them into a measurement signal, is positioned on the wheel axle and in front of the hub; the two essential parts of the sensor are therefore in relative rotation, but the transducer part is immobile relative to the sensor reading means, which provides easy signal transmission.

The advantage represented by elimination of a rotating electric connection or wireless transmission is greater than the constraint associated with the rotating movement between the two parts of the sensor, which in practice only requires minimal changes to usual sensors, or even no changes.

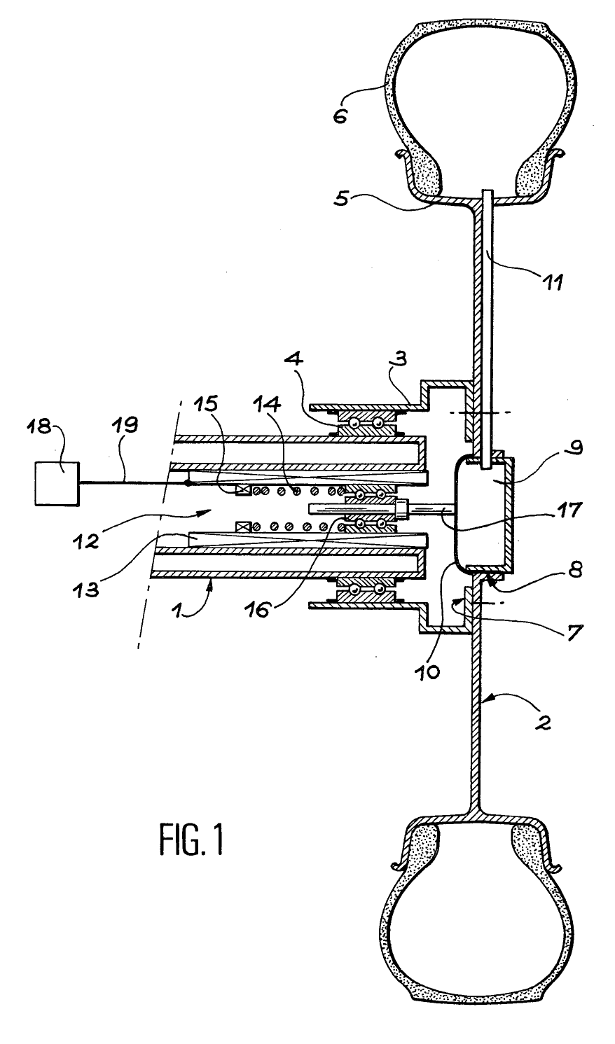

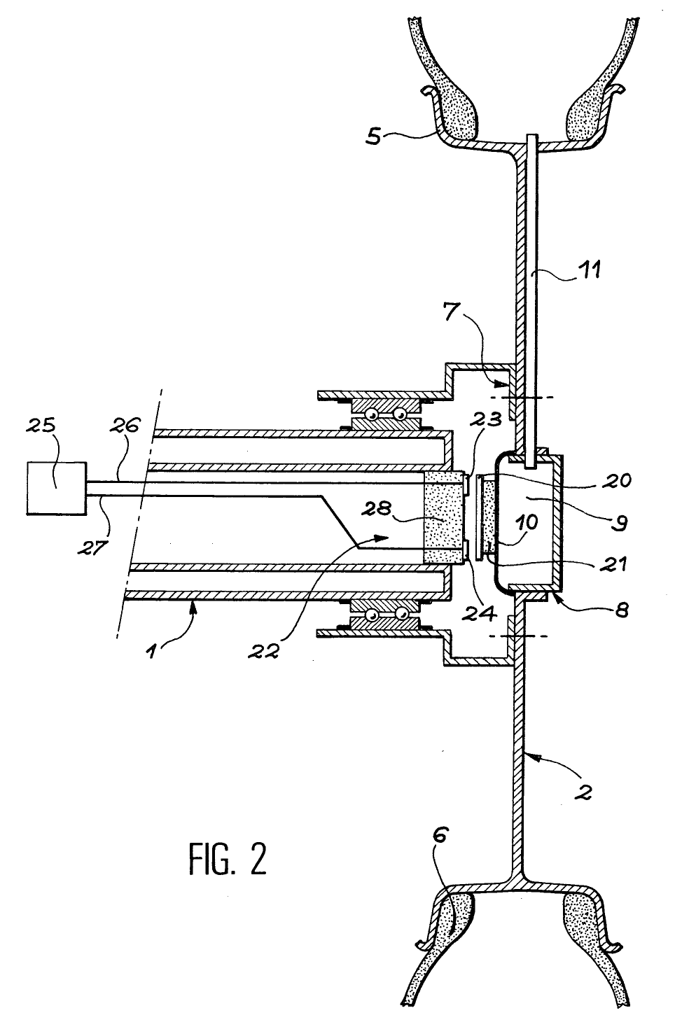

The invention is described in detail below by means of appended FIGS. 1 and 2 which illustrate two particular embodiments.

A vehicle which is only shown in part comprises an axle 1 connected to other fixed parts, and a wheel 2 whose hub 3 is mounted on axle 1 via a bearing 4 and whose wheel rim 5 carries a tyre 6. Hub 3 has a planar surface 7 covering the end of axle 1 and on which the sensitive part 8 of a pressure sensor is mounted, here consisting of a box on which a deformable membrane 10 is tensed facing the end of axle 1; the box and membrane 10 delimit a chamber 9 which a pressure-taking tube connection 11 links to the inside of tyre 6.

Axle 1 is reamed and contains a transducer part 12 complementary to sensitive part 8 of the pressure sensor. This transducer part 12 comprises windings 13 lining the reamed surface of the axle, a spring 14 surrounded by windings 13 and compressed between a rear abutment 15 and a front slide bearing 16 ; said slide bearing 16 carries a magnetic core 17 in the form of a feeler touching membrane 10.

Rotation of wheel 2 and of sensitive part 8 drives the magnetic core 17, but it is absorbed by bearing 16 and is not communicated to the remainder of transducer part 12. The pressure of tyre 6 causes proportional deformation of membrane 10 and a slide movement of magnetic core 17 against spring 14. Variable sinking of magnetic core 17 into windings 13 influences their magnetic coupling and the characteristics of a current emitted by a generator 18 via a line 19 and windings 13. Measurement of these characteristics gives the position of magnetic core 17 and the pressure in tyre 6.

Deformation of membrane 10 could be measured by means other than electromagnetic induction, such as optic means in combination with a laser. However another embodiment is described below in which the sensitive part 8 of the sensor is completed by a passive electrode 20 on the outer surface (facing axle 1) of membrane 10 via an insulation gasket 21. The transducer part (here 22) is much simpler than in FIG. 1 and comprises a pair of electrodes 23 and 24 positioned side by side on another electric gasket 28 covering the reaming of axle 1, and opposite respective parts of passive electrode 22, which are linked to a generator 25 by respective lines 26 and 27. Here, the deformation of membrane 10 translates as variation in the resistance of the circuit consisting of electrodes 23, 22 and 24 and lines 26 and 27.

1. Device for measuring the pressure of a tyre (6) fitted to a rim (5) of a wheel (2) and comprising a sensor and reading means (19,26,27; 18,25) leading to the sensor, characterized in that the sensor comprises a pressure-sensitive part (8) positioned on a wheel hub (3), a pressure-taking tube connection (11) extending from the sensitive part to the tyre, and a transducer part (12;22) positioned on an axle (1) of the wheel in front of the hub (2) and connected to the reading means.

2. Tyre pressure-measuring device as in claim 1, characterized in that the pressure-sensitive part comprises a chamber (9) with a deformable membrane (10) positioned in front of the axle.

3. Tyre pressure-measuring device as in claim 2, characterized in that the membrane and reading part are fitted with electrodes (20,23,24), and the transducer part with means for applying current to the electrodes.

4. Tyre pressure-measuring device as in claim 2, characterized in that the transducer part is fitted with a feeler (17) to palpate the membrane and a feeler bearing block (16) mounted sliding fashion in a bore of the axle.
